(19) United States
(12) Patent Application Publication
(10) Pub. No.: US 2016/0224229 A1
(43) Pub. Date: Aug. 4, 2016

(54) MEDICAL IMAGE PROCESSING APPARATUS AND MEDICAL IMAGE PROCESSING METHOD

(71) Applicant: Samsung Electronics Co., Ltd., Gyeonggi-do (KR)

(72) Inventors: Hyun-hee JO, Gyeonggi-do (KR); Seon-mi PARK, Gyeonggi-do (KR)

(21) Appl. No.: 14/992,565

(22) Filed: Jan. 11, 2016

(30) Foreign Application Priority Data
Jan. 29, 2015 (KR) 10-2015-0014585

(51) Int. Cl. G06F 3/0484; G06T 7/00

(52) U.S. Cl. CPC G06F 3/04847; G06T 7/0012; G06T 2200/24

(57) ABSTRACT

A medical image processing apparatus provides a contour correction of an object where a segmentation result is correctable via a smaller number of user inputs. The apparatus includes: a display screen configured to display an endo-contour image and an epi-contour image corresponding to a myocardial image; an input interface configured to receive a first user input for the endo-contour image and epi-contour image. A processor is configured to change the displayed size of the endo-contour image and epi-contour image in response to the first user input, wherein the display outputs a display of both of the changed endo-contour image and epi-contour image together.

### CLAIM OF PRIORITY

This application claims the benefit of Korean Patent Application No. 10-2015-0014585, filed on Jan. 29, 2015, in the Korean Intellectual Property Office, the disclosure of which is incorporated herein in its entirety by reference.

### BACKGROUND

1. Field of the Disclosure

The present disclosure relates to methods and apparatuses for processing a medical image. More particularly, the present disclosure relates to methods and apparatuses for processing a medical image which are capable of providing a user with a convenient editing environment.

2. Description of the Related Art

Medical imaging apparatuses are used to acquire images showing an internal structure of an object, typically a living being or a portion of the living being. Medical imaging apparatuses are non-invasive examination apparatuses that capture and process images of details of structures, tissue, fluid flow, etc., inside a body and provide the images to a user. A user, e.g., a medical practitioner, may use medical images output from one or more medical imaging apparatuses to diagnose a patient's condition and diseases.

Examples of medical imaging apparatuses may include, an X-ray apparatus, a computed tomography (CT) apparatus, an ultrasound apparatus, a magnetic resonance imaging (MRI) apparatus, etc. Among medical imaging apparatuses, an MRI apparatus uses a magnetic field to capture an image of an object, and is widely used in the accurate diagnosis of diseases because it shows stereoscopic images of bones, lumbar discs, joints, nerve ligaments, the heart, etc., at desired angles. For example, an MRI apparatus may determine the presence of a disease in a heart that beats over a period time by obtaining MR images of the heart at predetermined time intervals for analysis.

A user of an MRI apparatus (hereinafter, referred to as an operator, radiologist, or manipulator) may acquire an image by manipulating the MRI apparatus. Since the user is engaged in repeatedly manipulating the MRI apparatus over the entire life of the MRI apparatus, convenient manipulation of the MRI apparatus is an issue of great concern.

### SUMMARY

The present disclosure provides methods and apparatuses for processing a medical image that facilitate convenient user manipulation.

The present disclosure also provides methods and apparatuses for processing a medical image which provide for a contour correction of an object where a segmentation result may be corrected via a smaller number of user inputs.

Additional aspects of the disclosure will be set forth in part in the description which follows and, in part, will be understood by a person of ordinary skill from the description, or may be learned by practice of the presented exemplary embodiments.

According to an aspect of the disclosure, a medical image processing apparatus may include: a display configured to display an endo-contour image and an epi-contour image corresponding to a myocardial image; an input interface configured to receive a first user input for the endo-contour image and epi-contour image; and a processor configured to change the endo-contour image and epi-contour image in response to the first user input, wherein the display displays both of the changed endo-contour image and epi-contour image together.

The processor may adjust the displayed size of one or both of the endo-contour image and epi-contour image in response to the first user input.

The processor may decrease the displayed size of the endo-contour image and increase the displayed size of the epi-contour image in response to the first user input, or increase the displayed size of the endo-contour image and decrease the displayed size of the epi-contour image in response to the first user input.

The processor may adjust an area between the endo-contour image and epi-contour image in response to the first user input.

The processor may change a displayed shape of the endo-contour image or epi-contour image shown on the display, in response to the first user input.

The processor may generate the myocardial image based on received magnetic resonance imaging (MRI) data, produce the endo-contour image and epi-contour image corresponding to the myocardial image, and transmit the endo-contour image and epi-contour image to the display.

The endo-contour image and epi-contour image corresponding to the myocardial image may be generated using an algorithm selected from among a plurality of algorithms.

The first user input may be provided by operation of a button input or wheel input.

The processor may be configured to change the display of shapes of the endo-contour image or epi-contour image shown on the display based on an intensity of the myocardial image, in response to the first user input.

The processor may change displayed shapes of the endo-contour image or epi-contour image based on a variation in an intensity of the myocardial image, based on the first user input.

According to an aspect of the disclosure, a medical image processing apparatus may include: a display configured to display a plurality of contour images corresponding to an image of an object; an input interface configured to receive a first user input for the plurality of contour images; and a processor configured to change the plurality of contour images displayed in response to the first user input, wherein the display outputs a display of the changed plurality of contour images.

The processor may adjust the displayed sizes of the plurality of contour images based on the first user input.

The processor may decrease the displayed size of a first contour image from among the plurality of contour images and/or increase the displayed size of a second contour image from among the plurality of contour images in response to the first user input, or increase the displayed size of the first contour image and decrease the size of the second contour image in response to the first user input.

The processor may adjust an area of the display between the plurality of contour images in response to the first user input.

The processor may change the displayed shapes of the plurality of contour images in response to the first user input.

The processor may generate the image of the object based on received MRI data, and produces the plurality of contour images corresponding to the image of the object, and outputs the plurality of contour images to the display.

The plurality of contour images corresponding to the image of the object may be generated using one from among a plurality of algorithms.

The processor may change the display of shapes of the plurality of contour images based on an intensity of the image of the object, in response to the first user input.

The processor may change the display of shapes of the plurality of contour images based on a variation in an intensity of the image of the object, in response to the first user input.

According to an aspect of the disclosure, a medical image processing method may include: displaying an endo-contour image and an epi-contour image corresponding to a myocardial image; receiving a first user input for the endo-contour image and epi-contour image; changing display of the endo-contour image and epi-contour image in response to the first user input; and displaying both of the changed endo-contour image and epi-contour image together.

The changing the endo-contour image and epi-contour image may include adjusting sizes of the displayed endo-contour image and epi-contour image in response to the first user input.

The changing the endo-contour image and epi-contour image may include decreasing the displayed size of the endo-contour image and increasing the displayed size of the epi-contour image in response to the first user input, or include increasing the displayed size of the endo-contour image and decreasing the displayed size of the epi-contour image in response to the first user input.

The changing the endo-contour image and epi-contour image may include adjusting an area between the endo-contour image and epi-contour image in response to the first user input.

The changing of the display of the endo-contour image and epi-contour image may include changing shapes of the endo-contour image and epi-contour image in response to the first user input.

The changing of the display of the endo-contour and epi-contour images may include: generating the myocardial image based on received MRI data; producing the endo-contour image and epi-contour image corresponding to the myocardial image; and transmitting the endo-contour image and epi-contour image to the display.

The endo-contour image and epi-contour image corresponding to the myocardial image may be generated using an algorithm from among of a plurality of algorithms.

The first user input element may be a button input or a wheel input.

The changing the endo-contour image and epi-contour image may include changing shapes of the endo-contour image and epi-contour image based on an intensity of the myocardial image, in response to the first user input.

The changing of the display of the endo-contour image and epi-contour image may include changing the display of shapes of the endo-contour image and epi-contour image based on a variation in an intensity of the myocardial image, in response to the first user input.

According to an aspect of the present disclosure, a medical image processing method includes: displaying a plurality of contour images corresponding to an image of an object; receiving a first user input for the plurality of contour images; changing the plurality of contour images in response to the first user input; and displaying the changed plurality of contour images.

The changing of the display of the plurality of contour images may include adjusting sizes of the plurality of contour images being displayed in response to the first user input.

The changing of the display of the plurality of contour images may include decreasing the display size of a first contour image from among the plurality of contour images and increasing the display size of a second contour image from among the plurality of contour images in response to the first user input, or include increasing the display size of the first contour image and decreasing the display size of the second contour image in response to the first user input.

The changing of the display of the plurality of contour images may include adjusting an area between plurality of contour images in response to the first user input.

The changing the plurality of contour images may include changing shapes of plurality of contour images in response to the first user input.

The changing of the display of the plurality of contour images may include: generating the image of the object based on received MRI data; producing the plurality of contour images of the object; and transmitting the plurality of contour images to the display.

The plurality of contour images corresponding to the image of the object may be generated using an algorithm from among a plurality of algorithms.

The changing of the display of the plurality of contour images may include changing of the shapes of the plurality of contour images based on an intensity of the image of the object, in response to the first user input.

The changing of the display of the plurality of contour images may include changing shapes of the plurality of contour images based on a variation in an intensity of the image of the object, in response to the first user input.

According to an aspect of the disclosure, a non-transitory computer-readable recording medium has recorded thereon a machine readable code that when executed by one or more processors for performing the above medical image processing method.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a medical image processing apparatus according to an exemplary embodiment of the present disclosure;

FIG. 2A is a diagram illustrating a circular mask-based contour correction technique;

FIG. 2B illustrates a dot-based contour correction technique;

FIG. 2C and FIG. 2D are diagrams illustrating a correction technique using an active contour algorithm;

FIG. 3 is a flowchart of a medical image processing method according to an exemplary embodiment of the present disclosure;

FIG. 4A and FIG. 4B are diagrams illustrating a display shown in FIG. 1 according to an exemplary embodiment of the present disclosure;

FIG. 5 illustrates a medical image processing apparatus according to an exemplary embodiment of the present disclosure;

FIG. 6 is a flowchart of a medical image processing method according to an exemplary embodiment of the present disclosure;

FIG. 7A, FIG. 7B, FIG. 8A and FIG. 8B illustrate a method of adjusting sizes of a plurality of contour images according to a first user input, which is performed by the medical image processing apparatus of FIG. 5;

FIG. 9 is a flowchart of a medical image processing method according to an exemplary embodiment of the present disclosure;

FIG. 10A, FIG. 10B, FIG. 10C, FIG. 11, FIG. 12A, FIG. 12B FIG. 12C, and FIG. 13 illustrate a method of adjusting an area between a plurality of contour images in response to a first user input, which is performed by the medical image processing apparatus of FIG. 5;

FIG. 14 is a flowchart of a medical image processing method according to an exemplary embodiment of the present disclosure;

FIG. 15A and FIG. 15B illustrate a method of adjusting an area between a plurality of contour images according to a first user input, which is performed by the medical image processing apparatus 200 of FIG. 5;

FIG. 16 is a flowchart of a medical image processing method according to an exemplary embodiment of the present disclosure;

FIG. 17 is a schematic diagram of a general magnetic resonance imaging (MRI) system; and

FIG. 18 illustrates a configuration of a communication unit according to an exemplary embodiment of the present disclosure.

### DETAILED DESCRIPTION

Advantages and features of the one or more embodiments of the present disclosure and methods of accomplishing the same may be understood more readily by reference to the following detailed description of the embodiments and the accompanying drawings. In this regard, the present embodiments may have different forms and should not be construed as being limited to the descriptions set forth herein. Rather, these embodiments are provided so that this disclosure will be thorough and complete in terms of understanding and supporting the claimed subject matter and will fully convey the concept of the present embodiments to one of ordinary skill in the art, as the present disclosure will only be defined by the appended claims.

Terms used herein will now be briefly described and then one or more embodiments of the present disclosure will be described in detail.

All terms including descriptive or technical terms which are used herein should be construed as having meanings that are understood by one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the disclosure. Thus, the terms used herein have to be defined based on the meaning of the terms together with the description throughout the specification.

When a part “includes” or “comprises” an element, unless there is a particular description contrary thereto, the part can further include other elements, not excluding the other elements. Also, the term “unit” in the embodiments of the present disclosure refers to a statutory element, for example a software component loaded into hardware for execution, or a hardware component such as a field-programmable gate array (FPGA) or an application-specific integrated circuit (ASIC), and performs a specific function. However, the term “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” are associated with the smaller number of components and “units”, or may be divided into additional components and “units”.

Reference will now be made in detail to embodiments, examples of which are illustrated in the accompanying drawings. In the following description, well-known functions or constructions are not described in detail so as not to obscure the embodiments with unnecessary detail. As used herein, the term “and/or” includes any and all combinations of one or more of the associated listed items. Expressions such as “at least one of,” when preceding a list of elements, modify the entire list of claimed elements and do not modify the individual elements of the list.

In the present specification, an “image” may refer to multi-dimensional data composed of discrete image elements (e.g., pixels in a two-dimensional (2D) image and voxels in a three-dimensional (3D) image). For example, the image may be a medical image of an object captured by an X-ray apparatus, a computed tomography (CT) apparatus, a magnetic resonance imaging (MRI) apparatus, an ultrasound diagnosis apparatus, or another medical imaging apparatus.

Furthermore, in the present specification, an “object” may be a human, an animal, or a part of a human or animal. For example, the object may be an organ (e.g., the liver, the heart, the womb, the brain, a breast, or the abdomen), a blood vessel, or a combination thereof. Furthermore, the “object” may be a phantom. The phantom means a material having a density, an effective atomic number, and a volume that are approximately the same as those of an organism. For example, the phantom may be a spherical phantom having properties similar to the human body.

Furthermore, in the present specification, a “user” may be, but is not limited to, a medical expert, such as a medical doctor, a nurse, a medical laboratory technologist, or a technician who repairs a medical apparatus.

Furthermore, in the present specification, an “MR image” refers to an image of an object obtained by using the nuclear magnetic resonance principle.

Furthermore, in the present specification, a “pulse sequence” refers to continuity of signals repeatedly applied by an MRI apparatus. The pulse sequence may include a time parameter of a radio frequency (RF) pulse, for example, repetition time (TR) or echo time (TE).

Furthermore, in the present specification, a “pulse sequence schematic diagram” shows an order of events that occur in an MRI apparatus. For example, the pulse sequence schematic diagram may be a diagram showing an RF pulse, a gradient magnetic field, an MR signal, or the like according to time.

An MRI system is an apparatus for acquiring a sectional image of a part of an object by expressing, in a contrast comparison, a strength of a MR signal with respect to a radio frequency (RF) signal generated in a magnetic field having a specific strength. For example, if an RF signal that only resonates at a specific atomic nucleus (for example, a hydrogen atomic nucleus) is emitted for an instant toward the object placed in a strong magnetic field and then such emission stops, an MR signal is emitted from the specific atomic nucleus, and thus the MRI system may receive the MR signal and acquire an MR image. The MR signal denotes an RF signal emitted from the object. An intensity of the MR signal may be determined according to a density of a predetermined atom (for example, hydrogen) of the object, a relaxation time T1, a relaxation time T2, and a flow of blood or the like.

MRI systems include, for example, characteristics that are different from those of other imaging apparatuses. Unlike imaging apparatuses such as CT apparatuses that acquire images according to a direction of detection hardware, MRI systems may acquire 2D images or 3D volume images that are oriented toward an optional point. MRI systems do not expose objects or examiners to radiation, unlike CT apparatuses, X-ray apparatuses, position emission tomography (PET) apparatuses, and single photon emission CT (SPECT) apparatuses, may acquire images having high soft tissue contrast, and may acquire neurological images, intravascular images, musculoskeletal images, and oncologic images that are required to precisely capturing abnormal tissue.

Reference will now be made in detail to exemplary embodiments, examples of which are illustrated in the accompanying drawings, wherein like reference numerals refer to like elements throughout. In this regard, the present exemplary embodiments may have different forms and the appended claims should not be construed as being limited to the descriptions set forth herein. Accordingly, the exemplary embodiments are merely described below, by referring to the figures, to explain aspects.

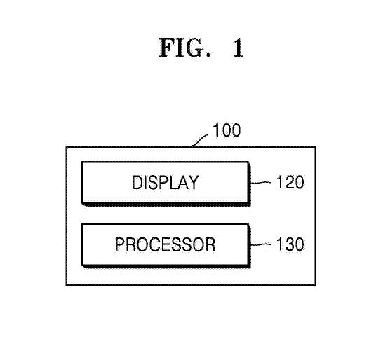

FIG. 1 illustrates a medical image processing apparatus 100 according to an exemplary embodiment.

The medical image processing apparatus 100 according to the present exemplary embodiment may be an apparatus for processing a medical image obtained by photographing an internal structure of an examinee or patient so that the user may easily analyze or edit the medical image. For example, the medical image processing apparatus 100 may process a medical image received from a medical imaging apparatus such as an X-ray apparatus, a CT apparatus, an ultrasound apparatus, or an MRI apparatus. It is hereinafter assumed that the medical imaging processing apparatus 100 processes an MR image.

Referring now to FIG. 1, the medical image processing apparatus 100 may include a display 120 and a processor 130. The processor 130, which includes hardware circuitry configured for operation and may comprise more than one processor, may receive MR data of an object and display an MR image to the user on the display 120.

The display 120 may output an MR image generated or reconstructed by the processor 130. Furthermore, the display 120 may display a graphical user interface (GUI) and information necessary for a user to manipulate an MRI system, such as user information and information about an object. Examples of the display 120 may include a cathode ray tube (CRT) display, a liquid crystal display (LCD), a plasma display panel (PDP) display, an organic light-emitting diode (OLED) display, a field emission display (FED), an LED display, a vacuum fluorescent display (VFD), a digital light processing (DLP) display, a flat panel display (FPD), a 3D display, a transparent display, etc., just to name some non-limiting possible examples.

When the medical image processing apparatus 100 generates an MR image of a moving object such as the heart, the processor 130 may generate MR image data from MR signals acquired from the moving object during a plurality of time intervals and for a plurality of slices. Furthermore, the processor 130 may divide the display of MR images into unit MR images respectively corresponding to the plurality of time intervals and the plurality of slices. The processor 130 may also segment an object in each of the unit MR images into a plurality of regions. For example, as shown in FIG. 7A, the processor 130 may segment display of an object into a plurality of regions along endo-cardium and epi-cardium of a myocardium.

For example, the processor 130 may delineate images, such as the left ventricular endo-cardium and epi-cardium from each of the unit MR images. The processor 130 may generate data of an endo-cardial contour image (hereinafter, referred to as an ‘endo-contour image’) and an epi-cardial contour image (hereinafter, referred to as an ‘epi-contour image’)) for each of the unit MR images and transmit the data to the display 120. Throughout the specification, a ‘contour image’ may refer to an image on which a contour of an object is delineated to easily identify the contour of the object.

In order for a user to obtain quantitative values that may be used for diagnosis from a medical image, the segmenting of images of a tumor, a blood vessel, etc. into a plurality of desired regions. Due to the length of time it takes a to segment several tens images, or even several hundreds of images, it is important for the user to easily and conveniently segment an image and correct a segmentation result.

The medical image processing apparatus 100 may correct endo-contour and epi-contour images by using a circular mask-based contour correction technique, a dot-based contour correction technique, a correction technique using an active contour algorithm, etc.

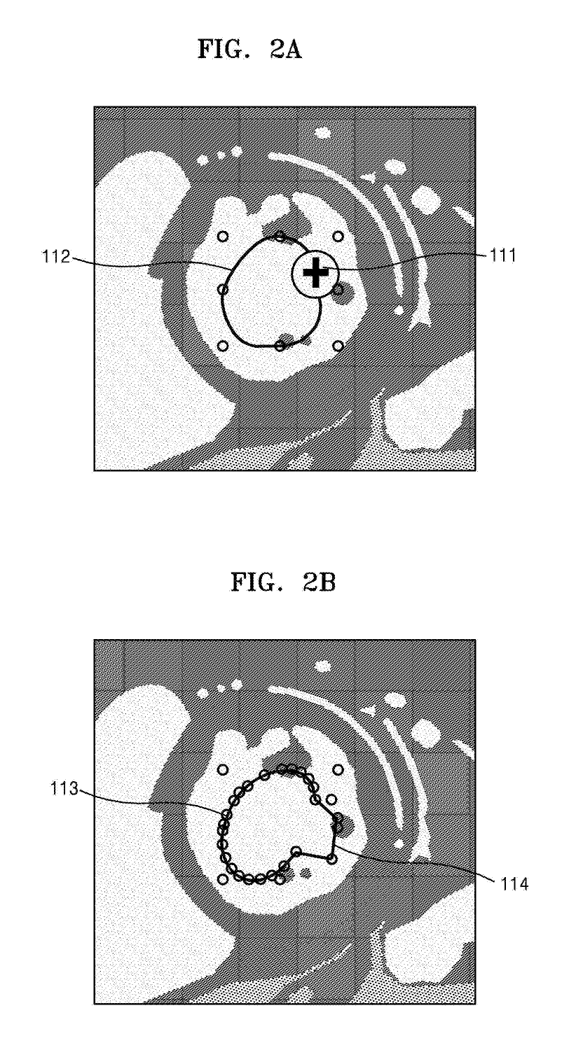

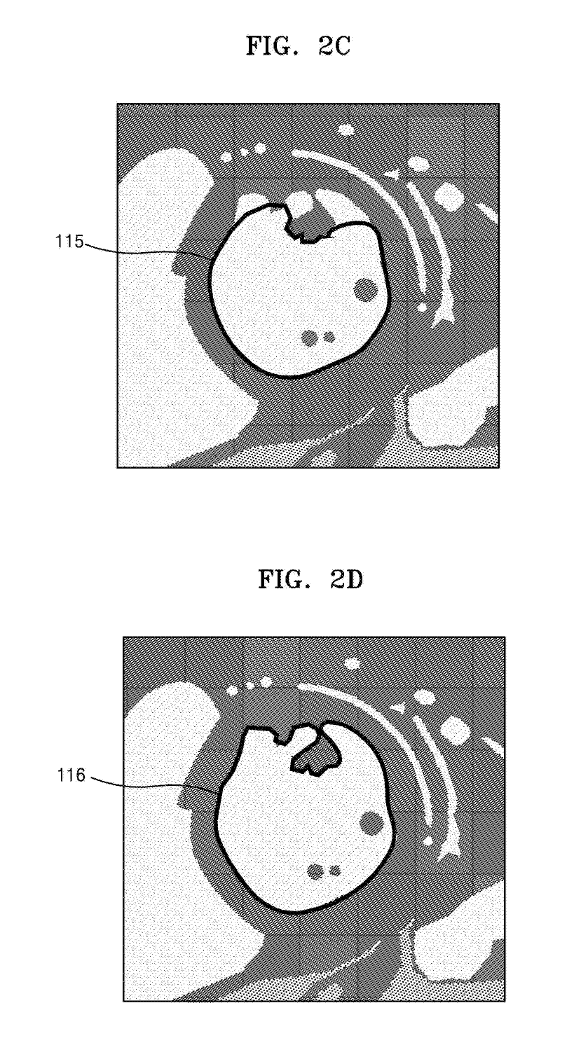

FIG. 2A is a diagram illustrating a circular mask-based contour correction technique.

The circular mask-based contour correction technique may be a technique for correcting endo-contour and epi-contour images via a circular mask 111. For example, the medical image processing apparatus 100 may define the circular mask 111 and allow a user to correct a contour 112 by dragging a wheel of a mouse inside or outside the contour 112. The medical image processing apparatus 100 may move the mask 111 by dragging the wheel and correct the endo-contour or epi-contour images according to movement of the mask 111.

FIG. 2B illustrates a dot-based contour correction technique.

The dot-based contour correction technique may be a technique for correcting endo-contour and epi-contour images via dots 113 arranged along a contour 114. For example, the medical image processing apparatus 100 may arrange the dots 113 on the contour 114 and allow the user to correct the contour 114 by moving the dots 113. The medical image processing apparatus 100 may move the dots 113 according to a user input and correct the endo-contour and epi-contour images according to movement of the dots 113.

FIGS. 2C and 2D are diagrams illustrating a correction technique using an active contour algorithm.

An active contour algorithm may be an algorithm for generating endo-contour and epi-contour images. For example, each time a user presses a button, an active contour algorithm may be performed to correct a currently drawn contour 115 and obtain a most suitable contour 116. The user may repeatedly click a button to correct the contour 115 until the user satisfies an endo- or epi-contour image. An endo-contour image segmented as shown in FIG. 2C may be updated as shown in FIG. 2D via an active contour algorithm according to a user input performed by clicking the button.

The correction techniques described with reference to FIGS. 2A through 2D are used to correct a single contour, and in the particular example the user may not correct both endo-contour and epi-contour images at a time. In other words, the user may not correct a plurality of contour images via a single input.

Referring back to FIG. 1, according to another exemplary embodiment, the processor 130 may change endo-contour and epi-contour images according to a single first user input. For example, to change the endo-contour and epi-contour images, the processor 130 may increase the display sizes of both the endo-contour and epi-contour images simultaneously or sequentially according to a single first user input.

According to an exemplary embodiment, the display 120 may update changes in both of the endo-contour and epi-contour images and display the changed endo-contour and epi-contour images. For example, each time the user presses a predetermined button, the processor 130 may decrease the displayed sizes of endo-contour and epi-contour images, and the display 120 may display the resulting endo-contour and epi-contour images having decreased sizes according to a single user input.

Thus, according to an exemplary embodiment, the medical image processing apparatus 100 may update a plurality of contour images simultaneously via a smaller number of inputs or user interactions, thereby facilitating convenient user manipulation.

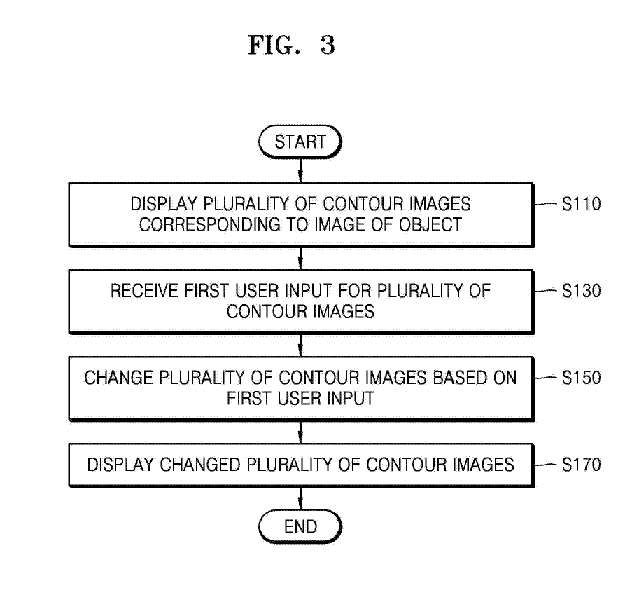

FIG. 3 is a flowchart of a medical image processing method according to an exemplary embodiment.

Referring now to FIG. 3, the medical image processing apparatus 100 may display a plurality of contour images corresponding to an image of an object (S110). For example, the medical image processing apparatus 100 may display endo-contour and epi-contour images corresponding to a myocardial image. As another example, the medical image processing apparatus 100 may display endo-contour and epi-contour images generated using various algorithms. As another example, the medical image processing apparatus 100 may display default values of endo-contour and epi-contour images.

The medical image processing apparatus 100 may receive a first user input for the plurality of contour images (S130). For example, the medical image processing apparatus 100 may receive a first user input for endo-contour and epi-contour images. In this case, the first user input may be an input for decreasing or increasing the sizes of the endo-contour and epi-contour images. Alternatively, the first user input may be an input for increasing or decreasing an area between the endo-contour and epi-contour images.

The first user input may be received in various ways. For example, the first user input may be received via a mouse, a key pad, a dome switch, a touch pad, a jog wheel, a jog switch, etc. Furthermore, an input unit for receiving the first user input may include a touch screen, a touch panel, and a keyboard.

For example, the first user input may be received via a motion recognition module and a touch recognition module. The touch recognition module may detect a user's touch gesture on a touch screen, and the motion recognition module may recognize a user's motion as an input and receive the first user input. The first user input may be received via a combination of two or more methods from among the above-described methods.

The medical image processing apparatus 100 may change the plurality of contour images in response to the first user input (S150). For example, the medical image processing apparatus 100 may change endo-contour and epi-contour images based on the first user input. The medical image processing apparatus 100 may receive a single user input and change the endo-contour and epi-contour images based on the single user input. In detail, the processor 130 may change display of the endo-contour and epi-contour images sequentially or simultaneously based on the single user input.

The medical image processing apparatus 100 may display the changed plurality of contour images (S170). For example, the medical image processing apparatus 100 may change both of the endo-contour and epi-contour images together and display the changed endo-contour and epi-contour images. The medical image processing apparatus 100 may update changes in the endo-contour and epi-contour images and display the changed endo-contour and epi-contour images simultaneously on the display 120.

Thus, the medical image processing method according to the present exemplary embodiment allows a plurality of contour images to be updated via a single user input, thereby reducing the number of interactions between the medical image processing apparatus 100 and the user and facilitating a convenient user manipulation.

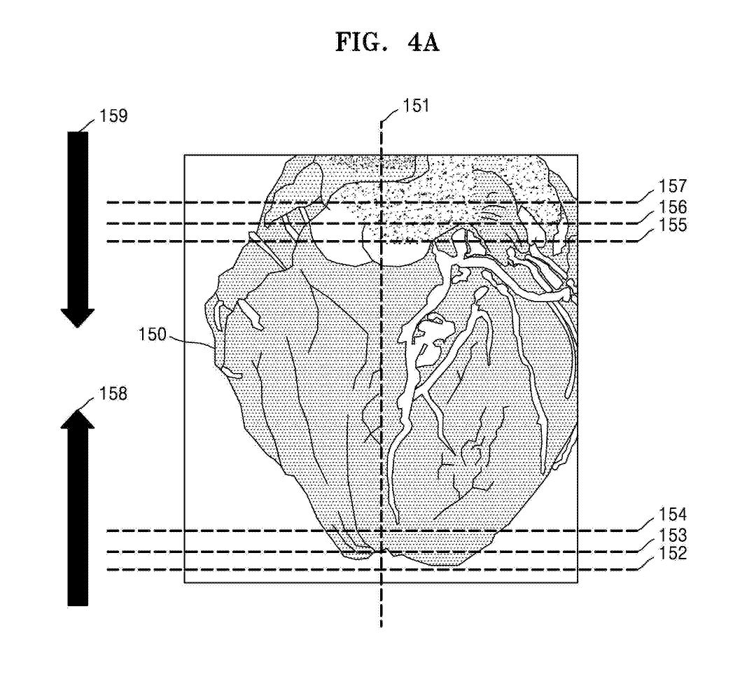

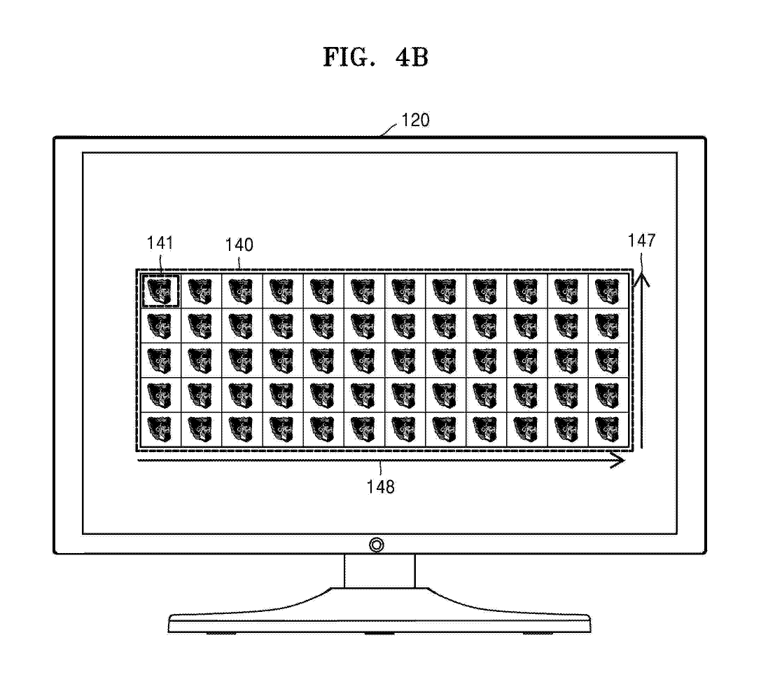

FIGS. 4A and 4B are diagrams illustrating the display 120 shown in FIG. 1 according to an exemplary embodiment.

Referring to FIGS. 1 and 4A, when the medical image processing apparatus 100 performs an MRI of a heart 150 to be imaged, an MR image is generated.

To check for the presence of a disease in the heart 150, a suspected point may be found for examination by obtaining MR images along several axes (e.g., a short-axis or long-axis) and analyzing the MR images. Acquisition of a short-axis MR image among cardiac MR images is a very important task for analysis of heart disease.

The medical image processing apparatus 100 may obtain short-axis MR images of a plurality of slices during a plurality of time intervals by performing an MRI along a short axis of the heart 150. The processor 130 of the medical image processing apparatus 100 may arrange the short-axis MR images, which are acquired during the plurality of time intervals and for the plurality of slices, in a time sequence and in an order that the plurality of slices are arranged, thereby generating a matrix image (140 of FIG. 4B).

As shown in FIG. 4A, the processor 130 may generate short-axis MR images corresponding to short-axis 152 through 157 that are planes perpendicular to the long-axis 151. Furthermore, the display 120 may display the matrix image 140 including generated MR images arranged according to positions of their corresponding plurality of slices. In the matrix image 140, the MR images may be arranged in a first or second direction, 158 or 159.

Referring to FIGS. 1 and 4B, the display 120 may display the matrix image 140. The matrix image 140 may include a plurality of unit MR images 141.

The processor 130 may be configured to arrange unit MR images corresponding to the same slice in a time sequence in a first direction 148 to generate rows of the matrix image 140. Furthermore, the processor 130 may arrange unit MR images corresponding to the same time interval for each slice in a second direction 147 to generate columns of the matrix image 140.

Each of the unit MR images may include an image object. For example, the image object may be an image object of the heart. For example, the image object may represent the endo-cardium or epi-cardium of the left ventricle. The image object may be a short-axis image showing the left ventricle.

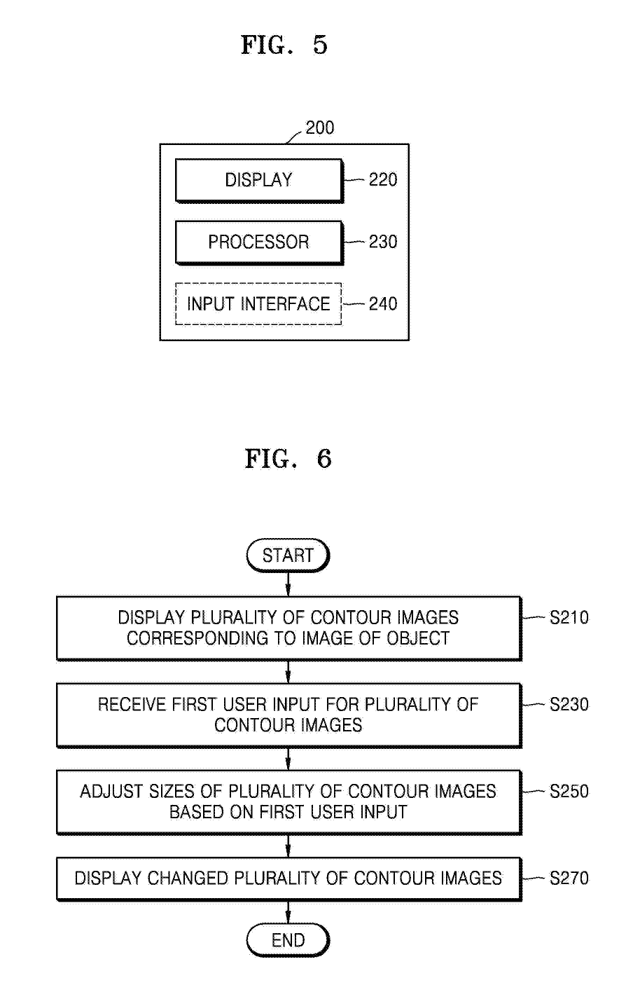

FIG. 5 illustrates a medical image processing apparatus 200 according to an exemplary embodiment.

The medical image processing apparatus 200 according to the present exemplary embodiment may include a display 220, a processor 230, and an input interface 240. Since the display 220 and the processor 230 may perform similar operations to those of the display 120 and the processor 130 shown in FIG. 1, the same descriptions as provided with respect to FIG. 1 will be omitted below.

The processor 230 may delineate left ventricular endo-contour and epi-cardia from each of the unit MR images. The processor 230 may change the sizes of endo-contour and epi-contour images based one single user input. For example, the processor 230 may decrease a size of the endo-contour image and increase a size of the epi-contour image based on a single user input. Alternatively, the processor 230 may increase the size of the endo-contour image and decrease the size of the epi-contour image based on a single user input.

To change the sizes of the endo-contour and epi-contour images, the medical image processing apparatus 100 may change the shapes, areas, and radii of endo-contour and epi-contours. The processor 130 may adjust the sizes of a plurality of endo-contour and epi-contour images simultaneously in response to a user input.

The display 220 may display both of the changed endo-contour and epi-contour images together. For example, each time the user presses a predetermined button, the processor 230 may decrease the sizes of endo-contour and epi-contour images, and the display 220 may display the resulting endo-contour and epi-contour images having decreased sizes based on a single user input.

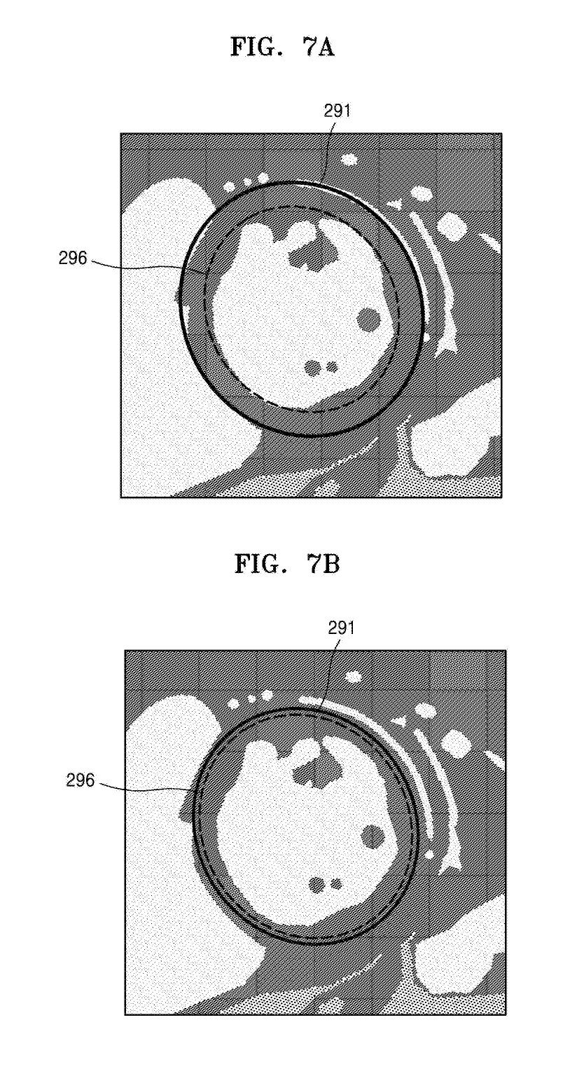

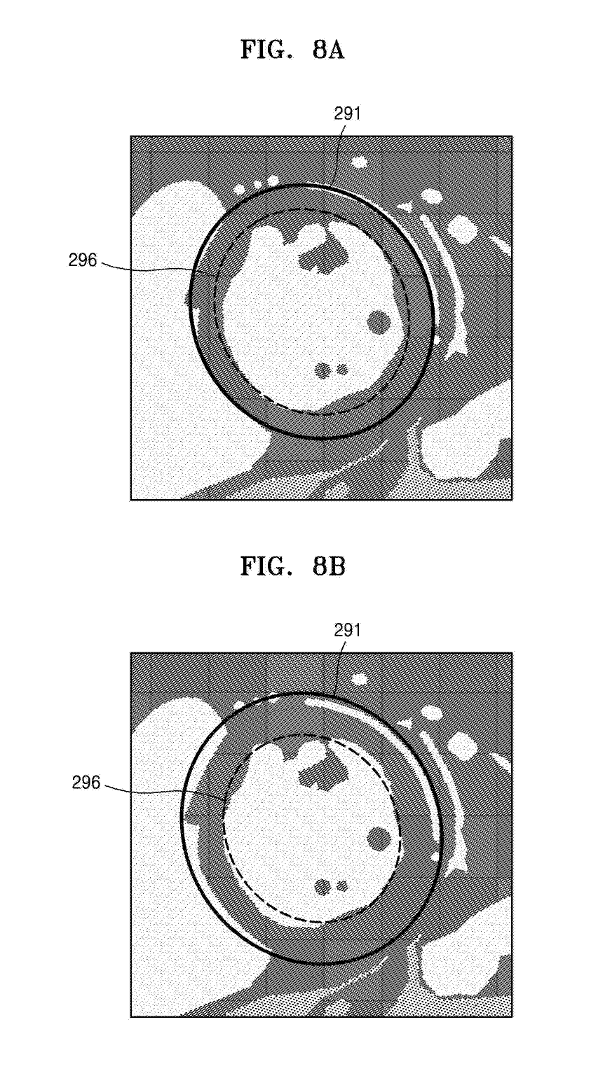

The input interface 240 may receive a user input from a user in various ways. For example, the input interface 240 may include a key pad, a dome switch, a touch pad, a jog wheel, a jog switch, etc. Furthermore, the input interface 240 may include a touch screen, a touch panel, and a keyboard. Operations of the medical image processing apparatus 200 will now be described in more detail with reference to FIG. 6.

FIG. 6 is a flowchart of a medical image processing method according to an exemplary embodiment.

Referring now to FIG. 6, operations S210, S230, and S270 are substantially similar as operations S110, S130, and S170, respectively, and thus detailed descriptions thereof will be omitted below.

The medical image processing apparatus 100 may adjust the sizes of a plurality of contour images in response to a first user input (S250). In detail, the processor 130 may adjust shapes, areas, and radii of endo-contour and epi-contours sequentially or simultaneously based on a single user input.

FIGS. 7A and 7B and FIGS. 8A and 8B illustrate a method of adjusting sizes of a plurality of contour images in response to a first user input, which is performed by the medical image processing apparatus 200 of FIG. 5.

As shown in FIG. 7A, the display 220 may display an endo-cardial contour image (hereinafter, referred to as an ‘endo-contour image’) 296 and an epi-cardial contour image (hereinafter, referred to as an ‘epi-contour image’) 291. The processor 230 may receive a first user input and increase a size of the endo-contour image 296 and decrease a size of the epi-contour image 291. Referring to FIG. 7B, the display 220 may display a larger version of the endo-contour image 296 and a smaller version of the epi-contour image 291.

The display 220 may display an endo-contour image 296 and an epi-contour image 291 as shown in FIG. 8A. The processor 230 may receive a first user input and decrease a size of the endo-contour image 296 and increase a size of the epi-contour image 291. As shown in FIG. 8B, the display 220 may update the endo-contour image 296 and epi-contour image 291 to display a smaller version of the endo-contour image 296 and a larger version of the epi-contour image 291.

Thus, a medical image processing method according to an exemplary embodiment allows a plurality of contour images to be changed via a single user input, thereby reducing the number of interactions between a medical image processing apparatus and a user and facilitating a convenient user manipulation.

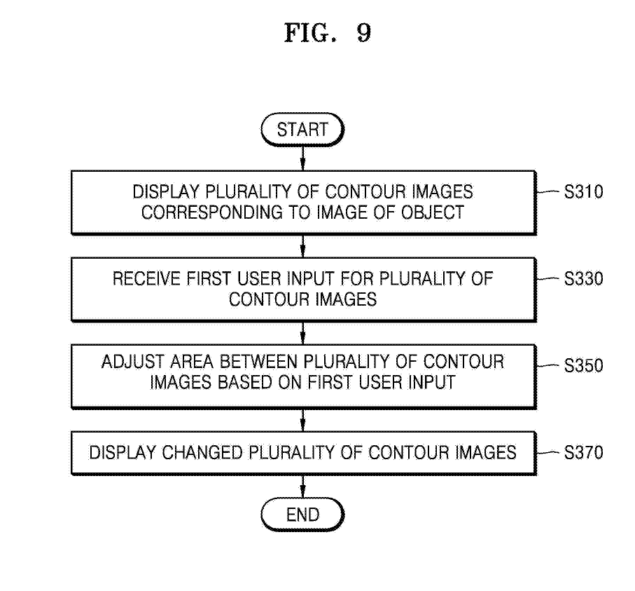

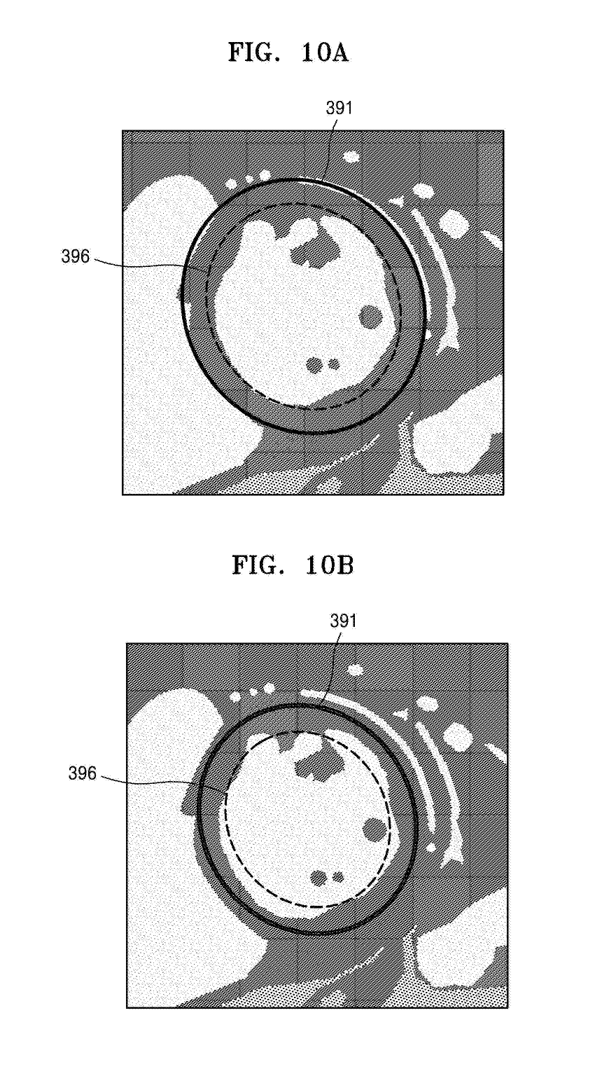

FIG. 9 is a flowchart of a medical image processing method according to an exemplary embodiment.

Referring now to FIG. 9, operations S310, S330, and S370 are substantially the same as operations S110, S130, and S170 shown in FIG. 3, respectively, and thus detailed descriptions thereof will be omitted below.

The medical image processing apparatus 200 may adjust an area between a plurality of contour images in response to a first user input (S350). The processor 230 may sequentially or simultaneously change display of an area between endo-contour and epi-contour images based on a single user input. For example, the processor 230 may change the display of endo-contour and epi-contour images generated using various algorithms. The processor 230 may change endo-contour and epi-contour images via the active contour algorithm described with reference to FIGS. 2C and 2D.

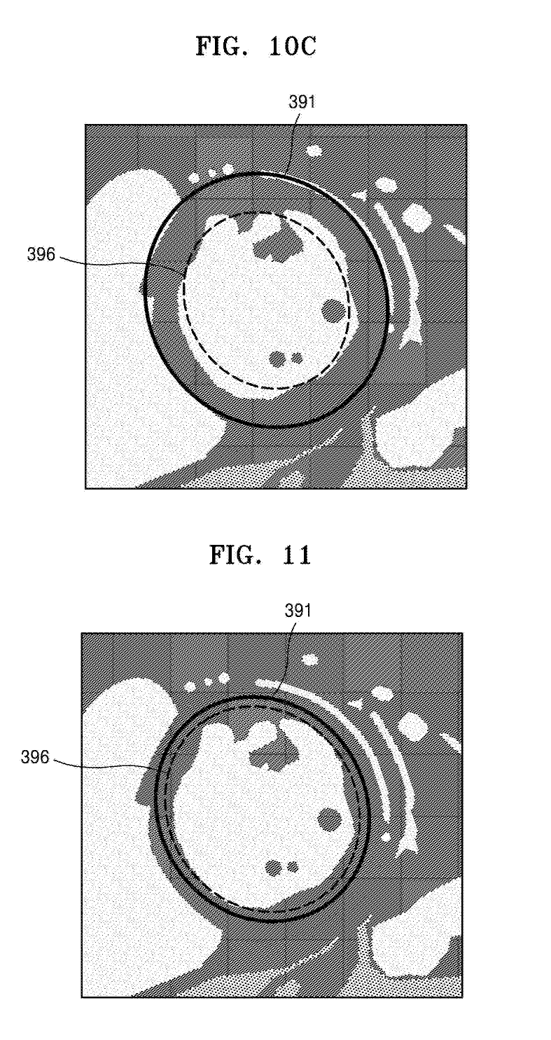

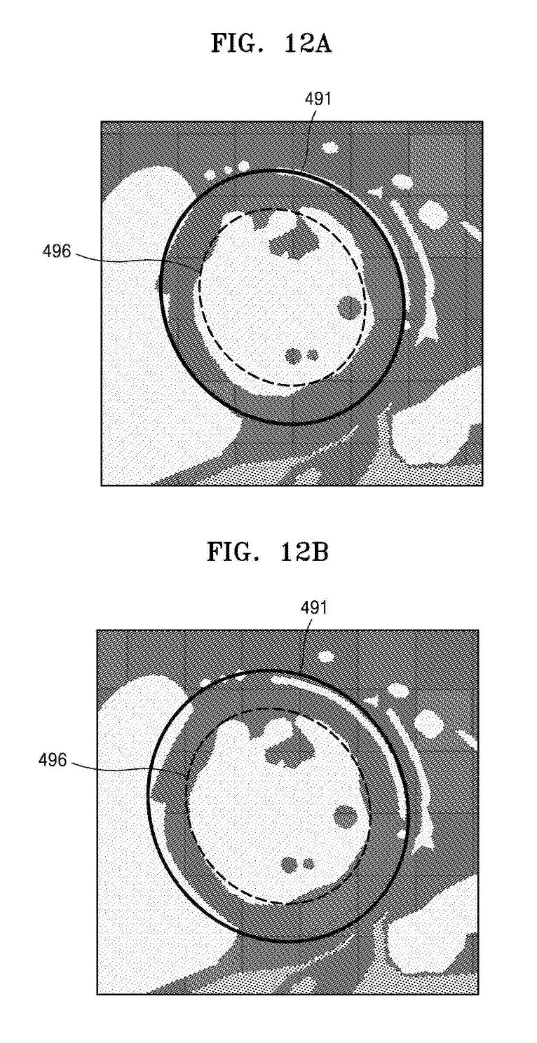

FIGS. 10A through 10C, FIG. 11, FIGS. 12A through 12C, and FIG. 13 illustrate a method of adjusting an area between a plurality of contour images displayed in response to a first user input, which is performed by the medical image processing apparatus 200 of FIG. 5.

The display 220 may display an endo-contour image 396 and an epi-contour image 391, as shown in FIGS. 10A through 10C. The display 220 may over-segment the epi-contour image 391 as shown in FIG. 10A. In the specification, over-segmentation may refer to delineation of a contour that is larger than an endo-cardial image or epi-cardial image.

The display 220 may under-segment the endo-contour image 396, as shown in FIG. 10B. In the specification, under-segmentation may refer to delineation of a contour that is smaller than an epi-cardial image or endo-cardial image.

Referring now to FIG. 10C, the display 220 may over-segment the epi-contour image 391 and under-segment the endo-contour image 396.

Referring now to FIG. 11, the processor 230 may receive a first user input and change the endo-contour image 396 and epi-contour image 391 shown in FIGS. 10A through 10C by decreasing an area between the endo-contour and epi-contour images 396 and 391. As shown in FIG. 11, the display 220 may display a larger version of the endo-contour image 396 and/or a smaller version of the epi-contour image 391.

The display 220 may display an endo-contour image 496 and an epi-contour image 491, as shown in FIGS. 12A through 12C. Referring to FIG. 12A, the display 220 may under-segment the epi-contour image 491. Referring to FIG. 12B, the display 220 may over-segment the endo-contour image 496, as shown in FIG. 12B. Referring to FIG. 12C, the display 220 may under-segment the epi-contour image 491 and over-segment the endo-contour image 496.

Referring to FIG. 13, the processor 230 may receive a first user input and change the display of the endo-contour and epi-contour images 496 and 491 shown in FIGS. 12A through 12C by increasing an area between the endo-contour image 496 and epi-contour image 491. As shown in FIG. 13, the display 220 may output a smaller version of the endo-contour image 496 and/or a larger version of the epi-contour image 491.

Thus, a medical image processing method according to an exemplary embodiment allows a plurality of contour images to be changed via a single user input, thereby reducing the number of interactions between a medical image processing apparatus and a user and facilitating a convenient user manipulation.

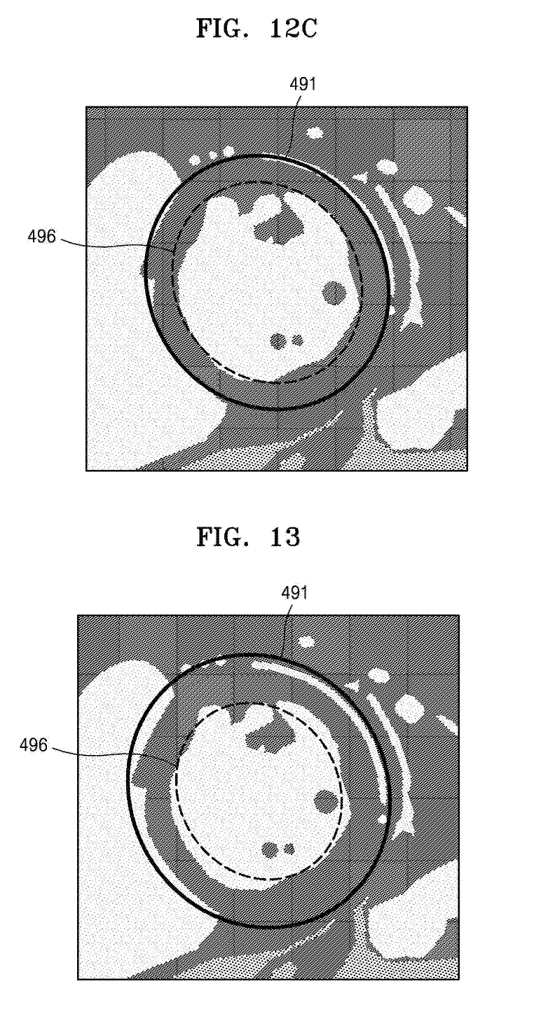

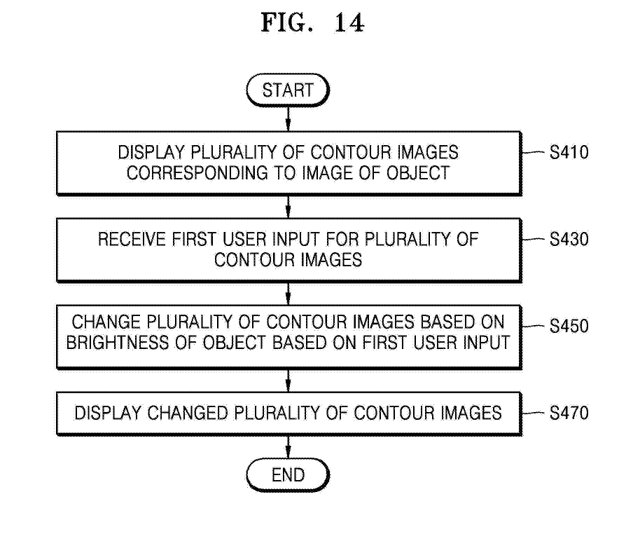

FIG. 14 is a flowchart of a medical image processing method according to an exemplary embodiment.

Referring now to FIG. 14, operations S410, S430, and S470 are substantially similar to operations S110, S130, and S170 shown in FIG. 3, respectively, and thus detailed descriptions thereof will be omitted below.

The medical image processing apparatus 200 may change a plurality of contour images based on an intensity of an image of an object, in response to a first user input (S450). The processor 230 may sequentially or simultaneously change display of the shapes of endo-contour and epi-contour images based on a single user input. For example, the processor 230 may change the endo-contour and epi-contour images generated via various algorithms based on an intensity of the image of the object. The intensity of the image of the object may be a pixel value or grey value thereof.

For example, the processor 230 may change the display of endo-contour and epi-contour images so that a portion of the image of the object having an intensity greater than or equal to a predetermined intensity is included in contours drawn on the endo-contour and epi-contour images. The processor 230 may change an image so that a portion the image of the object having a pixel value greater than or equal to 100 is included in a contour.

As another example, the processor 230 may change the display of endo-contour and epi-contour images so that contours pass through a portion of the image of the object having an intensity greater than a predetermined intensity. Furthermore, the processor 230 may change display of the endo-contour and epi-contour images so that a portion of the image of the object having an intensity less than or equal to a predetermined intensity is excluded from the endo-contour and epi-contour images.

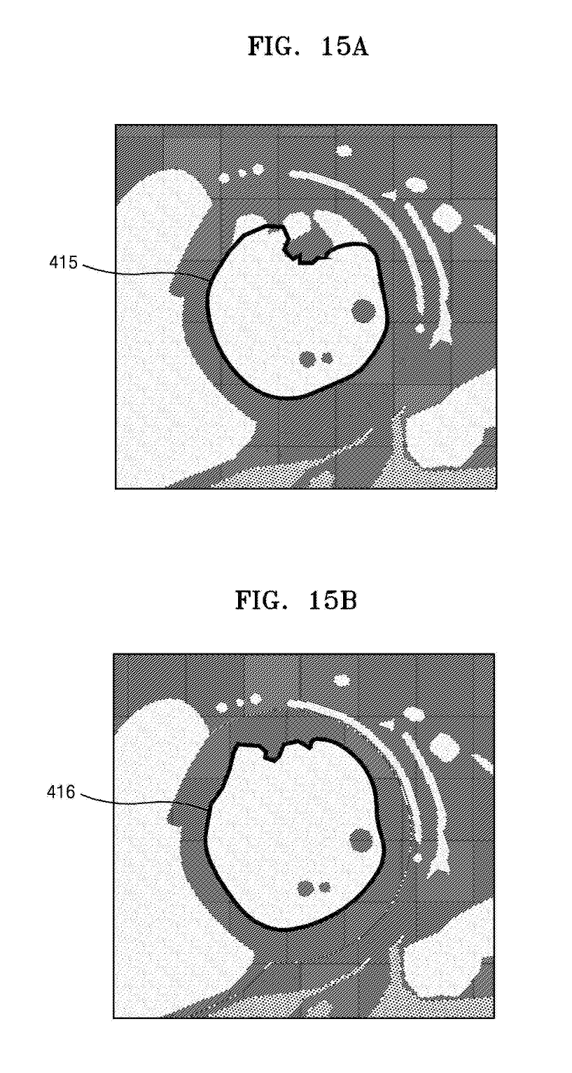

For example, a contour 415 shown in FIG. 15A may be changed to a contour 416 shown in FIG. 15B. The contour 416 may encompass a portion having an intensity greater than or equal to a predetermined value, compared to the contour 415.

In addition, the method of FIG. 14 and at least one of the methods of FIGS. 6 and 9 may be repeatedly applied to processing of a medical image. For example, an area between a plurality of contour images may be adjusted in response to a first user input, and a contour image may be changed together with the area based on an intensity of myocardial image.

Thus, a medical image processing method according to an exemplary embodiment allows a plurality of contour images to be changed based on an intensity of an image of an object based on a single user input, thereby reducing the number of interactions between a medical image processing apparatus and a user and facilitating a convenient user manipulation.

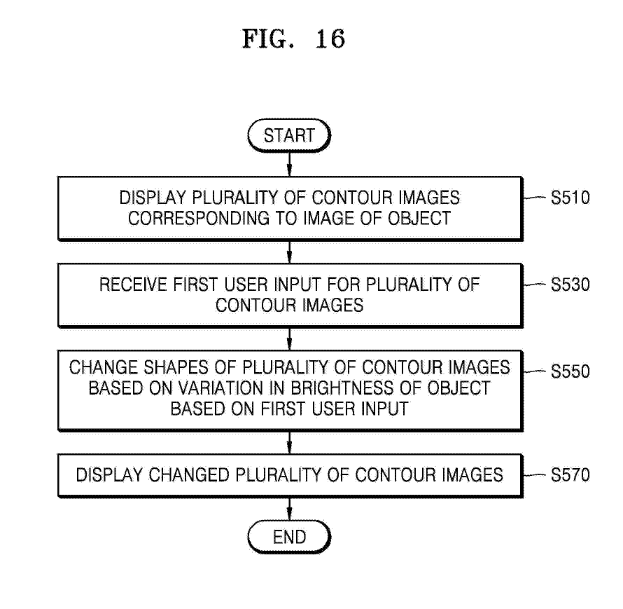

FIG. 16 is a flowchart of a medical image processing method according to an exemplary embodiment.

Referring now to FIG. 16, operations S510, S530, and S570 are substantially similar to operations S110, S130, and S170 shown in FIG. 3, respectively, and thus detailed descriptions thereof will be omitted below.

The medical image processing apparatus 200 may change display of a plurality of contour images based on a variation in an intensity of an image of an object, in response to a first user input (5550). The processor 230 may sequentially or simultaneously change display of the shapes of endo-contour and epi-contour images based on a single user input. For example, the processor 230 may change display of the endo-contour and epi-contour images generated via various algorithms based on an intensity of the image of the object. The intensity of the image of the object may be a pixel value or grey value thereof.

For example, the processor 230 may change display of the endo-contour and epi-contour images so that contours pass through a portion of the image of the object having a variation in an intensity, which is greater than or equal to a predetermined value. The processor 230 may change display of the endo-contour and epi-contour images so that contours pass through a portion of the image of the object having a variation in an intensity greater than or equal to 5. As shown in the contour 416 of FIG. 15B, a contour image may be changed by forming a contour on the contour image in a portion having a variation in an intensity greater than or equal to a predetermined value.

In addition, the method of FIG. 16 and at least one of the methods of FIGS. 6, 9, 14 may be repeatedly applied to processing a medical image. For example, an area between a plurality of contour images may be adjusted in response to a first user input, and a display of a contour image may be changed together with the area based on a variation in an intensity of a myocardial image.

Thus, a medical image processing method according to an exemplary embodiment allows a display of a plurality of contour images to be changed based on a variation in an intensity via a single user input, thereby reducing the number of interactions between a medical image processing apparatus and a user and facilitating a convenient user manipulation.

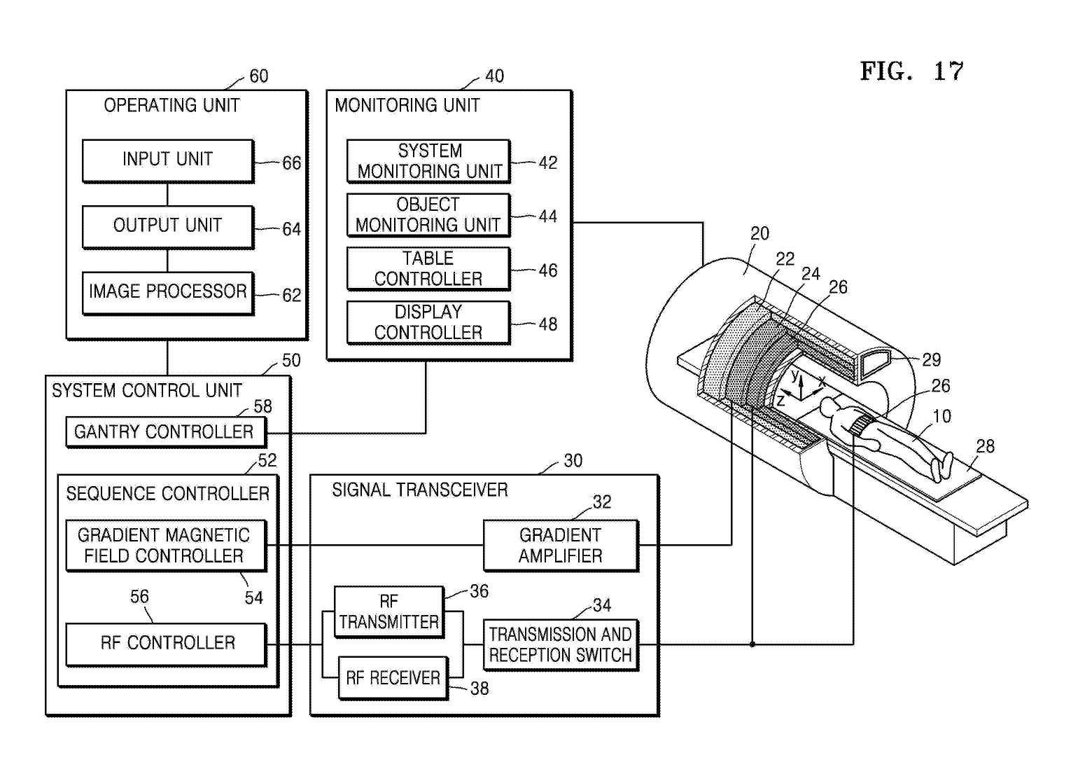

FIG. 17 is a block diagram of a general MRI system. Referring to FIG. 17, the general MRI system may include a gantry 20, a signal transceiver 30, a monitoring unit 40, a system control unit 50, and an operating unit 60.

The gantry 20 prevents external emission of electromagnetic waves generated by a main magnet 22, a gradient coil 24, and an RF coil 26. A magnetostatic field and a gradient magnetic field are formed in a bore in the gantry 20, and an RF signal is emitted toward an object 10.

The main magnet 22, the gradient coil 24, and the RF coil 26 may be arranged in a predetermined direction of the gantry 20. The predetermined direction may be a coaxial cylinder direction. The object 10 may be disposed on a table 28 that is capable of being inserted into a cylinder along a horizontal axis of the cylinder.

The main magnet 22 generates a magnetostatic field or a static magnetic field for aligning magnetic dipole moments of atomic nuclei of the object 10 in a constant direction. A precise and accurate MR image of the object 10 may be obtained due to a magnetic field generated by the main magnet 22 being strong and uniform.

The gradient coil 24 includes X, Y, and Z coils for generating gradient magnetic fields in X-, Y-, and Z-axis directions crossing each other at right angles. The gradient coil 24 may provide location information of each region of the object 10 by differently inducing resonance frequencies according to the regions of the object 10.

The RF coil 26 may emit an RF signal toward a patient and receive an MR signal emitted from the patient. In detail, the RF coil 26 may transmit, toward atomic nuclei included in the patient and having precessional motion, an RF signal having the same frequency as that of the precessional motion, stop transmitting the RF signal, and then receive an MR signal emitted from the atomic nuclei included in the patient.

For example, in order to transit an atomic nucleus from a low energy state to a high energy state, the RF coil 26 may generate and apply an electromagnetic wave signal that is an RF signal corresponding to a type of the atomic nucleus, to the object 10. When the electromagnetic wave signal generated by the RF coil 26 is applied to the atomic nucleus, the atomic nucleus may transit from the low energy state to the high energy state. Then, when electromagnetic waves generated by the RF coil 26 disappear, the atomic nucleus to which the electromagnetic waves were applied transits from the high energy state to the low energy state, thereby emitting electromagnetic waves having a Lamor frequency. In other words, when the applying of the electromagnetic wave signal to the atomic nucleus is stopped, an energy level of the atomic nucleus is changed from a high energy level to a low energy level, and thus the atomic nucleus may emit electromagnetic waves having a Lamor frequency. The RF coil 26 may receive electromagnetic wave signals from atomic nuclei included in the object 10.

The RF coil 26 may be realized as one RF transmitting and receiving coil having both a function of generating electromagnetic waves each having an RF that corresponds to a type of an atomic nucleus and a function of receiving electromagnetic waves emitted from an atomic nucleus. Alternatively, the RF coil 26 may be realized as a transmission RF coil having a function of generating electromagnetic waves each having an RF that corresponds to a type of an atomic nucleus, and a reception RF coil having a function of receiving electromagnetic waves emitted from an atomic nucleus.

The RF coil 26 may be fixed to the gantry 20 or may be detachable. When the RF coil 26 is detachable, the RF coil 26 may be an RF coil for a part of the object, such as a head RF coil, a chest RF coil, a leg RF coil, a neck RF coil, a shoulder RF coil, a wrist RF coil, or an ankle RF coil.

The RF coil 26 may communicate with an external apparatus via wires and/or wirelessly, and may also perform dual tune communication according to a communication frequency band.

The RF coil 26 may communicate with an external apparatus via wires and/or wirelessly, and may also perform dual tune communication according to a communication frequency band.

The RF coil 26 may be a transmission exclusive coil, a reception exclusive coil, or a transmission and reception coil according to methods of transmitting and receiving an RF signal.

The RF coil 26 may be an RF coil having various numbers of channels, such as 16 channels, 32 channels, 72 channels, and 144 channels.

The gantry 20 may further include a display 29 disposed outside the gantry 20 and a display (not shown) disposed inside the gantry 20. The gantry 20 may provide predetermined information to the user or the object 10 through the display 29 and the display respectively disposed outside and inside the gantry 20.

The signal transceiver 30 includes hardware such as a transmitter, receiver or transceiving hardware that may be configured to control the gradient magnetic field formed inside the gantry 20, i.e., in the bore, according to a predetermined MR sequence, and control transmission and reception of an RF signal and an MR signal.

The signal transceiver 30 may include a gradient amplifier 32, a transmission and reception switch 34, an RF transmitter 36, and an RF receiver 38.

The gradient amplifier 32 drives the gradient coil 24 included in the gantry 20, and may supply a pulse signal for generating a gradient magnetic field to the gradient coil 24 under the control of a gradient magnetic field controller 54. By controlling the pulse signal supplied from the gradient amplifier 32 to the gradient coil 24, gradient magnetic fields in X-, Y-, and Z-axis directions may be synthesized.

The RF transmitter 36 and the RF receiver 38 may drive the RF coil 26. The RF transmitter 36 may supply an RF pulse in a Lamor frequency to the RF coil 26, and the RF receiver 38 may receive an MR signal received by the RF coil 26.

The transmission and reception switch 34 may adjust transmitting and receiving directions of the RF signal and the MR signal. For example, the transmission and reception switch 34 may emit the RF signal toward the object 10 through the RF coil 26 during a transmission mode, and receive the MR signal from the object 10 through the RF coil 26 during a reception mode. The transmission and reception switch 34 may be controlled by a control signal output by an RF controller 56.

The monitoring unit 40 may monitor or control the gantry 20 or devices mounted on the gantry 20. The monitoring unit 40 includes hardware and may include a system monitoring unit 42, an object monitoring unit 44, a table controller 46, and a display controller 48. All of the foregoing “units” include hardware and are statutory elements. For example, the table controller and display controller are statutory elements and include at least one processor or microprocessor.

The system monitoring unit 42 may monitor and control a state of the magnetostatic field, a state of the gradient magnetic field, a state of the RF signal, a state of the RF coil 26, a state of the table 28, a state of a device measuring body information of the object 10, a power supply state, a state of a thermal exchanger, and a state of a compressor.

The object monitoring unit 44 monitors a state of the object 10. In detail, the object monitoring unit 44 may include a camera for observing a movement or position of the object 10, a respiration measurer for measuring the respiration of the object 10, an electrocardiogram (ECG) measurer for measuring the electrical activity of the object 10, or a temperature measurer for measuring a temperature of the object 10.

The table controller 46 controls a movement of the table 28 where the object 10 is positioned. The table controller 46 may control the movement of the table 28 according to a sequence control of a sequence controller 50. For example, during moving imaging of the object 10, the table controller 46 may continuously or discontinuously move the table 28 according to the sequence control of the sequence controller 52, and thus the object 10 may be photographed in a field of view (FOV) larger than that of the gantry 20. The sequence controller 50 also includes a processor or microprocessor.

The display controller 48 controls the display 29 disposed outside the gantry 20 and the display disposed inside the gantry 20. In detail, the display controller 48 may control the display 29 and the display to be on or off, and may control a screen image to be output on the display 29 and the display. Also, when a speaker is located inside or outside the gantry 20, the display controller 48 may control the speaker to be on or off, or may control sound to be output via the speaker.

The system control unit 50 may include the sequence controller 52 for controlling a sequence of signals formed in the gantry 20, and a gantry controller 58 for controlling the gantry 20 and the devices mounted on the gantry 20.

The sequence controller 52 may include the gradient magnetic field controller 54 for controlling the gradient amplifier 32, and the RF controller 56 for controlling the RF transmitter 36, the RF receiver 38, and the transmission and reception switch 34. The sequence controller 52 may control the gradient amplifier 32, the RF transmitter 36, the RF receiver 38, and the transmission and reception switch 34 according to a pulse sequence received from the operating unit 60. Here, the pulse sequence includes all information required to control the gradient amplifier 32, the RF transmitter 36, the RF receiver 38, and the transmission and reception switch 34. For example, the pulse sequence may include information about a strength, an application time, and application timing of a pulse signal applied to the gradient coil 24.

The operating unit 60 may request the system control unit 50 to transmit pulse sequence information while controlling an overall operation of the MRI system.

The operating unit 60 may include an image processor 62 for receiving and processing the MR signal received by the RF receiver 38, an output unit 64, and an input unit 66.

The image processor 62 may process the MR signal received from the RF receiver 38 so as to generate MR image data of the object 10.

The image processor 62 receives the MR signal received by the RF receiver 38 and performs any one of various signal processes, such as amplification, frequency transformation, phase detection, low frequency amplification, and filtering, on the received MR signal.

The image processor 62 may arrange digital data in a k space (for example, also referred to as a Fourier space or a frequency space) of a memory, and rearrange the digital data into image data via 2D or 3D Fourier transformation.

If needed, the image processor 62 may perform a composition process or difference calculation process on the image data. The composition process may be an addition process performed on a pixel or a maximum intensity projection (MIP) process performed on a pixel. The image processor 62 may store not only the rearranged image data but also image data on which a composition process or a difference calculation process is performed, in a memory (not shown) or an external server.

The image processor 62 may perform any of the signal processes on the MR signal in parallel. For example, the image processor 62 may perform a signal process on a plurality of MR signals received by a multi-channel RF coil in parallel so as to rearrange the plurality of MR signals into image data.

The image processor 62 according to an exemplary embodiment may be the processor 130 shown in FIG. 1 or the processor 230 shown in FIG. 5.

The output unit 64 may output image data generated or rearranged by the image processor 62 to the user. The output unit 64 may also output information required for the user to manipulate the MRI system, such as a user interface (UI), user information, or object information. The output unit 64 may be a speaker, a printer, a cathode-ray tube (CRT) display, a liquid crystal display (LCD), a plasma display panel (PDP), an organic light-emitting device (OLED) display, a field emission display (FED), a light-emitting diode (LED) display, a vacuum fluorescent display (VFD), a digital light processing (DLP) display, a flat panel display (FPD), a 3-dimensional (3D) display, a transparent display, or any one of other various output devices that are well known to one of ordinary skill in the art.

The user may input object information, parameter information, a scan condition, a pulse sequence, or information about image composition or difference calculation by using the input unit 66. The input unit 66 may be a keyboard, a mouse, a track ball, a voice recognizer, a gesture recognizer, a touch screen, or any one of other various input devices that are well known to one of ordinary skill in the art.

The signal transceiver 30, the monitoring unit 40, the system control unit 50, and the operating unit 60 are separate components in FIG. 1, but it should be understood to one of ordinary skill in the art that respective functions of the signal transceiver 30, the monitoring unit 40, the system control unit 50, and the operating unit 60 may be performed by another component. For example, the image processor 62 converts the MR signal received from the RF receiver 38 into a digital signal in FIG. 1, but alternatively, the conversion of the MR signal into the digital signal may be performed by the RF receiver 38 or the RF coil 26.

The gantry 20, the RF coil 26, the signal transceiver 30, the monitoring unit 40, the system control unit 50, and the operating unit 60 may be connected to each other by wire or wirelessly, and when they are connected wirelessly, the MRI system may further include an apparatus (not shown) for synchronizing clock signals therebetween. Communication between the gantry 20, the RF coil 26, the signal transceiver 30, the monitoring unit 40, the system control unit 50, and the operating unit 60 may be performed by using a high-speed digital interface, such as low voltage differential signaling (LVDS), asynchronous serial communication, such as a universal asynchronous receiver transmitter (UART), a low-delay network protocol, such as error synchronous serial communication or a controller area network (CAN), optical communication, or any of other various communication methods that are well known to one of ordinary skill in the art.

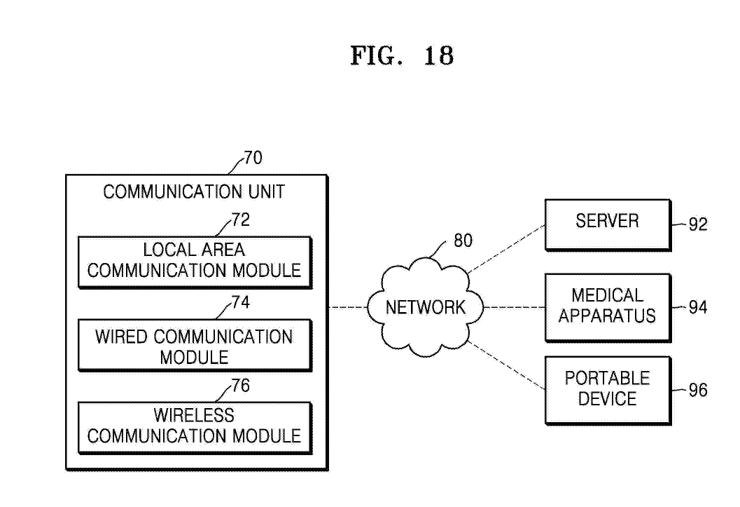

FIG. 18 is a block diagram of a communication unit 70 according to an embodiment of the present disclosure. Referring to FIG. 18, the communication unit 70 may be connected to at least one of the gantry 20, the signal transceiver 30, the monitoring unit 40, the system control unit 50, and the operating unit 60 of FIG. 1.

The communication unit 70, which includes hardware, may transmit and receive data to and from a hospital server or another medical apparatus in a hospital, which is connected through a picture archiving and communication system (PACS), and perform data communication according to the digital imaging and communications in medicine (DICOM) standard.

As shown in FIG. 18, the communication unit 70 may be connected to a network 80 by wire or wirelessly to communicate with a server 92, a medical apparatus 94, or a portable device 96.

In detail, the communication unit 70 may transmit and receive data related to the diagnosis of an object through the network 80, and may also transmit and receive a medical image captured by the medical apparatus 94, such as a CT apparatus, an MRI apparatus, or an X-ray apparatus. In addition, the communication unit 70 may receive a diagnosis history or a treatment schedule of the object from the server 92 and use the same to diagnose the object. The communication unit 70 may perform data communication not only with the server 92 or the medical apparatus 94 in a hospital, but also with the portable device 96, such as a mobile phone, a personal digital assistant (PDA), or a laptop of a doctor or patient.

Also, the communication unit 70 may transmit information about a malfunction of the MRI system or about a medical image quality to a user through the network 80, and receive a feedback regarding the information from the user.

The communication unit 70 may include at least one component enabling communication with an external apparatus.

For example, the communication unit 70 may include a local area communication module 72, a wired communication module 74, and a wireless communication module 76. The local area communication module 72 refers to a module for performing local area communication with an apparatus within a predetermined distance. Examples of local area communication technology according to an embodiment of the present disclosure include, but are not limited to, a wireless local area network (LAN), Wi-Fi, Bluetooth, ZigBee, Wi-Fi direct (WFD), ultra wideband (UWB), infrared data association (IrDA), Bluetooth low energy (BLE), and near field communication (NFC).

The wired communication module 74 refers to a module including hardware configured for performing communication by using an electric signal or an optical signal. Examples of wired communication technology according to an embodiment of the present disclosure include wired communication techniques using a pair cable, a coaxial cable, and an optical fiber cable, and other well known wired communication techniques.

The wireless communication module 76 includes hardware to transmit and receive a wireless signal to and from at least one selected from a base station, an external apparatus, and a server in a mobile communication network. Here, the wireless signal may be a voice call signal, a video call signal, or data in any one of various formats according to transmission and reception of a text/multimedia message.

The apparatuses and methods of the disclosure can be implemented in hardware, and in part as firmware or via the execution of software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry that is configured for operation. Under the broadest reasonable interpretation, the appended claims constitute statutory subject matter in compliance with 35 U.S.C. §101 and none of the elements are software per se. No claim element herein is to be construed under the provisions of 35 U.S.C. 112, sixth paragraph, unless the element is expressly recited using the phrase “means for”.

The definition of the terms “unit” or “module” as referred to herein are to be understood as constituting hardware circuitry such as a CCD, CMOS, SoC, AISC, FPGA, at least one processor or microprocessor (a controller or control unit) configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se. For example, the image processor in the present disclosure, and any references to an input unit and/or an output unit both comprise hardware circuitry configured for operation.

The embodiments of the present disclosure may be embodied as computer programs executed by hardware, and as such may be implemented in general-use digital computers that execute the programs using a computer-readable recording medium.

Examples of the computer-readable recording medium include magnetic storage media (e.g., ROM, floppy disks, hard disks, etc.), optical recording media (e.g., CD-ROMs or DVDs), etc.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims. Accordingly, the above embodiments and all aspects thereof are examples only and are not limiting.

What is claimed is:

1. A medical image processing apparatus comprising:
a display configured to output display of an endo-contour image and an epi-contour image corresponding to a myocardial image;
an input interface configured to receive a first user input associated with the display of the endo-contour image and epi-contour image; and
a processor configured to change a display of the endo-contour image and epi-contour image in response to the first user input,
wherein the display outputs both of the changed endo-contour image and epi-contour image together.

2. The medical image processing apparatus of claim 1, wherein the processor adjusts a display size of one or more of the endo-contour image and epi-contour image in response to the first user input received by the input interface.

3. The medical image processing apparatus of claim 2, wherein the processor decreases the display size of the endo-contour image and increases the display size of the epi-contour image in response to the first user input, or increases the display size of the endo-contour image and decreases the display size of the epi-contour image in response to the first user input received by the input interface.

4. The medical image processing apparatus of claim 1, wherein the processor adjusts an area of display between the endo-contour image and epi-contour image in response to the first user input received by the input interface.

5. The medical image processing apparatus of claim 4, wherein the processor changes the display of shapes of the endo-contour image and epi-contour image in response to the first user input received by the input interface.

6. The medical image processing apparatus of claim 4, wherein the processor generates the myocardial image based on received magnetic resonance imaging (MRI) data, produces the endo-contour image and epi-contour image corresponding to the myocardial image, and transmits the endo-contour image and epi-contour image to the display for output.

7. The medical image processing apparatus of claim 1, wherein the endo-contour image and epi-contour image corresponding to the myocardial image are generated using an algorithm selected from among a plurality of algorithms.

8. The medical image processing apparatus of claim 1, wherein the first user input is received by the input interface via at least one of a button input or a wheel input.

9. The medical image processing apparatus of claim 1, wherein the processor changes the display of shapes of the endo-contour image and epi-contour image based on an intensity of the myocardial image, in response to the first user input received by the input interface.

10. The medical image processing apparatus of claim 1, wherein the processor changes the display of shapes of the endo-contour image and epi-contour image based on a variation in an intensity of the myocardial image, in response to the first user input received by the input interface.

11. A medical image processing apparatus comprising:
a display configured to output display of a plurality of contour images corresponding to an image of an object;
an input interface configured to receive a first user input associated with display of the plurality of contour images; and
a processor configured to change display of the plurality of contour images in response to the first user input received by the input interface,
wherein the display displays the changed plurality of contour images.

12. The medical image processing apparatus of claim 11, wherein the processor adjusts a displayed size of each of the plurality of contour images in response to the first user input received by the input interface.

13. The medical image processing apparatus of claim 12, wherein the processor decreases the display size of a first contour image from among the plurality of contour images and increases the display size of a second contour image from among the plurality of contour images in response to the first user input, or increases the display size of the first contour image and decreases the display size of the second contour image in response to the first user input.

14. The medical image processing apparatus of claim 11, wherein the processor adjusts an area of the display between the plurality of contour images in response to the first user input received by the input interface.

15. The medical image processing apparatus of claim 14, wherein the processor changes a displayed shape of each of the plurality of contour images in response to the first user input received by the input interface.

16. The medical image processing apparatus of claim 14, wherein the processor generates the image of the object based on received magnetic resonance imaging (MRI) data, produces the plurality of contour images corresponding to the image of the object, and transmits the plurality of contour images to the display for output.

17. The medical image processing apparatus of claim 11, wherein the plurality of contour images corresponding to the image of the object are generated using one algorithm selected from among a plurality of algorithms.

18. The medical image processing apparatus of claim 11, wherein the processor changes the display of shapes of each of the plurality of contour images based on an intensity of the image of the object, in response to the first user input received by the input interface.

19. The medical image processing apparatus of claim 11, wherein the processor changes the display of shapes of each of the plurality of contour images based on a variation in an intensity of the image of the object, in response to the first user input received by the input interface.

20. A medical image processing method comprising:
displaying an endo-contour image and an epi-contour image corresponding to a myocardial image;
receiving by an input interface a first user input associated with display of the endo-contour image and epi-contour image;
changing display of the endo-contour image and epi-contour image in response to the first user input; and
displaying both of the changed endo-contour image and epi-contour image together.

21. The medical image processing method of claim 20, wherein the changing display of the endo-contour image and epi-contour image comprises adjusting sizes of the endo-contour image and epi-contour image being displayed in response to the first user input received by the input interface.

22. The medical image processing method of claim 21, wherein the changing display of the endo-contour image and epi-contour image comprises decreasing a display size of the endo-contour image and increasing the display size of the epi-contour image in response to the first user input, or
wherein the changing of the endo-contour image and epi-contour image comprises increasing the display size of the endo-contour image and decreasing the display size of the epi-contour image in response to the first user input.

23. The medical image processing method of claim 20, wherein the changing display of the endo-contour image and epi-contour image comprises adjusting an area of display between the endo-contour image and epi-contour image in response to the first user input.

24. The medical image processing method of claim 23, wherein the changing the endo-contour image and epi-contour image comprises changing the displayed of shapes of the endo-contour image and epi-contour image in response to the first user input received by the input interface.

25. The medical image processing method of claim 23, wherein the changing the endo-contour and epi-contour images comprises:
generating the myocardial image based on received magnetic resonance imaging (MRI) data;
producing the endo-contour image and epi-contour image corresponding to the myocardial image; and
providing the endo-contour image and epi-contour image to the display for output.

26. The medical image processing method of claim 20, wherein the endo-contour image and epi-contour image corresponding to the myocardial image are generated using an algorithm selected from among of a plurality of algorithms.

27. The medical image processing method of claim 20, wherein the first user input is received by the input interface via at least one of a button input or wheel input.

28. The medical image processing method of claim 20, wherein the changing the endo-contour image and epi-contour image comprises changing the display shapes of the endo-contour image and epi-contour image based on an intensity of the myocardial image, in response to the first user input received by the input interface.

29. The medical image processing method of claim 20, wherein the changing the endo-contour image and epi-contour image comprises changing the display shapes of the endo-contour image and epi-contour image based on a variation in an intensity of the myocardial image, in response to the first user input received by the input interface.

30. A medical image processing method comprising:
displaying a plurality of contour images corresponding to an image of an object;
receiving by an input interface a first user input for the plurality of contour images;
changing the plurality of contour images in response to the first user input; and
displaying the changed plurality of contour images.

31. The medical image processing method of claim 30, wherein the changing the plurality of contour images comprises:
adjusting a display size of each of the plurality of contour images in response to the first user input received by the input interface.

32. The medical image processing method of claim 31, wherein the changing the plurality of contour images comprises:
decreasing a display size of a first contour image from among the plurality of contour images and increasing the display size of a second contour image from among the plurality of contour images in response to the first user input, or
wherein the changing the plurality of contour images comprises increasing the display size of the first contour image and decreasing the display size of the second contour image in response to the first user input received by the input interface.

33. The medical image processing method of claim 30, wherein the changing the plurality of contour images comprises adjusting an area between plurality of contour images in response to the first user input.

34. The medical image processing method of claim 30, wherein the changing the plurality of contour images comprises changing shapes of plurality of contour images in response to the first user input.

35. The medical image processing method of claim 30, wherein the changing the plurality of contour images comprises:
generating the image of the object based on received magnetic resonance imaging (MRI) data;
producing the plurality of contour images of the object; and
providing the plurality of contour images to the display for output.

36. The medical image processing method of claim 30, wherein the plurality of contour images corresponding to the image of the object are generated using an algorithm selected from among a plurality of algorithms.

37. The medical image processing method of claim 30, wherein the changing the plurality of contour images comprises changing the display of shapes of the plurality of contour images based on an intensity of the image of the object, in response to the first user input received by the input interface.

38. The medical image processing method of claim 30, wherein the changing the plurality of contour images comprises changing the display of shapes of the plurality of contour images based on a variation in an intensity of the image of the object, in response to the first user input received by the input interface.

39. A non-transitory computer-readable recording medium having recorded thereon a program for performing the medical image processing method of claim 20.
